(19) United States
(12) Patent Application Publication
(10) Pub. No.: US 2015/0278843 A1
(43) Pub. Date: Oct. 1, 2015

(54) SYSTEM AND METHOD FOR APPLYING STORE CREDIT TO A PRESENTED BILL FOR A DISCOUNT WHEN PAID IN STORE OR BY MOBILE WALLET

(71) Applicants: Brian Lawe, Ave Marie, FL (US); Radu Cugut, Timisoara (RO)

(72) Inventors: Brian Lawe, Ave Marie, FL (US); Radu Cugut, Timisoara (RO)

(21) Appl. No.: 14/671,802

(22) Filed: Mar. 27, 2015

Related U.S. Application Data
(60) Provisional application No. 61/973,481, filed on Apr. 1, 2014.

(51) Int. Cl. G06Q 30/02; G06Q 20/36

(52) U.S. Cl. CPC G06Q 30/0222; G06Q 20/36

(57) ABSTRACT

A system and method enables a merchant to input a pending bill amount to a blue-tooth enabled beacon device and wirelessly relay that bill amount to a consumer's mobile device, which will then relay the amount to an internet connected server, which will securely calculate and apply the customer's store credit amount as a discount to the original bill, returning the updated amounts to the customer's mobile device for either manual payment or for payment using the customer's mobile wallet choice and subsequently the consumer mobile device will relay the appropriate net bill information to the blue-tooth enabled beacon device for display and then manual updating of a POS register.

### CROSS-REFERENCE TO RELATED APPLICATION

This application claims the benefit of priority of U.S. provisional application No. 61/973,481, filed Apr. 1, 2014, the contents of which are herein incorporated by reference.

### BACKGROUND OF THE INVENTION

The present invention relates generally to discounts provided or redeemed at a merchant's point-of-sale relayed using a wireless transmission device and manual data entry.

Retail merchants use various methods of rewarding customers to drive additional sales and consumer loyalty. Generally these methods include price discounting, issuing store credits or giving away free items or service discounts to consumers who can apply their store credits as a discount against a future payment. At the time of the future payment, the consumer requests their appropriate store credit amount be applied to their bill and a net due amount, after the store credit is applied, is paid by the consumer, thereby enabling a discount and gaining related customer loyalty and repeat sales.

Using store credit as a form of discounting is preferred by merchants because store credit is initially an accounting entry only. Likewise, store credit is of high perceived value to consumers who “own” the store credit and can choose to apply it to future payments reducing the bill amount by an equal amount. When issuing a store credit, no actual cash expense is incurred by a merchant and no cash is actually given to consumers; their bill is discounted. Moreover, store credit has no value unless it used by the assigned consumer in a subsequent purchase under the rules established by the merchant issuing the store credit.

While very attractive as a form of discounting to both merchants and consumers, the use of store credits is problematic. Specifically, the appropriate tracking and applying of store credits during subsequent purchases poses significant hurdles and accounting/security issues for merchants issuing and applying store credits. Most merchants' existing point-of-sale systems do not have the ability to track, calculate and apply store credits automatically. Merchants wishing to issue store credits to customers to drive future sales need a way to efficiently track, apply and account for issued store credits at the time of any subsequent payment. Moreover, store credit is expected to be applied in any form of store credit.

In most cases, the process for a merchant to issue, track and apply store credit is a manual, laborious process. The merchant does this manually to be assured that the tracking and applying issued store credits is robust and secure. However, the merchant must also have a means to quickly and easily apply and account for usage of store credit during subsequent consumer payments.

A merchant with a simple electronic or manual cash-register would have to invest a significant amount to upgrade their point-of-sale system to have a fully automated mechanism for tracking, applying and accounting for store credits. Even if they invested such an amount, most POS upgrades require a consumer to have a matching loyalty card or some additional mechanism for tracking and presenting their issued store credit. Merchants are also restricted to the mechanism of paying allowed at the upgraded POS. For instance, the upgraded POS might not accept a consumer's mobile wallet payment.

Neither the upgraded POS investment nor the manual tracking method is ideal for many merchants who use simple cash-registers which have only the ability to total up various items for sale, apply a discount amount to the items and calculate the tax and totals for the customer's bill.

The advent of data-enabled smart phones or other intelligent mobile devices provides a possible vehicle beyond the POS register, to track, apply and account for store credit by individual customers at the retail checkout.

However, as these relate to store credits, merchants still require certainty that the consumer does not have the ability to manipulate store credit calculations or manipulate the accounting/tracking of store credit if done on their mobile device. In other words, merchants need to be assured that the information they access regarding store credit amounts to apply is sent from a secured and accurate source. Since the merchant's simple cash-registers do not have the ability to do so and since relying on a consumer's mobile device for the information poses security risks, one method to track the store credit automatically is by using the customer's mobile device only as a relay mechanism to access the internet, where the tracking, applying and accounting for the store credit could operate independently and securely.

Many consumers now have smart mobile devices which do access the internet through data plans or over Wi-Fi connections. These devices can relay information generated by a store credit tracking service on the internet through the consumer's mobile device without calculating or tracking anything, directly to the merchant.

While even if the information exchange is limited only to being relayed through the consumer's mobile device from the internet service, the merchant would still not have easy access to view the store credit information and act upon it if they must rely on the consumer's mobile device to view the information. Therefore a new device is needed to receive the information from the internet server through the consumer's mobile device.

A recently introduced innovation in retailing is known as Bluetooth low-energy beacons. These beacons have the capacity to allow a smart mobile device to communicate with the beacon. A beacon owned and controlled by the merchant provides a mechanism for relaying appropriate store credit information from the internet, through the consumer's mobile device to the beacon in a secure way.

The use of mobile devices in retail also opens up the possibility for payment via the consumer's mobile device itself. Mobile wallets, such as Google Wallet and PayPal, allow a mobile enabled user to pay bills using their mobile device. This relatively new payment option provides a cost-saving opportunity for the retailer and a time-saving opportunity for both the retailer and consumer. Accepting such payments implies the merchant needs a way to independently confirm that the payment was complete. Independent confirmation could come from an internet connected server, relaying information via the consumer's mobile device to the merchant's beacon device. All of this could be done without costly point-of-sale upgrades and without manual recording and tracking of store credits by the merchant.

In sum, merchants need a way to securely track store credits, to securely have store credit applied to a presented bill, and a way to have the store credit amount automatically and accurately applied for payment either using the consumer's mobile wallet or manually at the merchant's point of sale.

### SUMMARY OF THE INVENTION

In one aspect of the present invention, a method for applying store credit to a presented bill for a discount comprises transmitting a bill amount, entered into a merchant device, from the merchant device to a consumer mobile device; receiving the bill amount on the consumer mobile device; relaying the bill amount to an internet connected server from the consumer mobile device; presenting the bill amount on the consumer mobile device; applying a calculated consumer store credit to the bill amount received by the internet connected server; transmitting an updated bill amount from the internet connected server back to the consumer mobile device; recording a consumer payment method choice on the consumer mobile device for the updated bill amount to be paid; and processing a mobile wallet payment or displaying store credit discount amount and instructions on the consumer mobile device.

In another aspect of the present invention, a merchant device to transfer a bill amount, tax amount, tip amount and a store credit discount amount to and from a consumer mobile device, comprises a microprocessor; a control program; a wireless transceiver; a display; a keypad; and an external memory, wherein the merchant device uses the microprocessor to operate the control program to receive a pre-tax and tax amount entered through the keypad; and the control program transmits, via the wireless transceiver, the amounts to the consumer mobile device, wherein the consumer mobile device transmits updated amounts back to the merchant device and the display shows the updated amounts for a merchant to input on a merchant's point of sale register.

In a further aspect of the present invention, a system comprises an internet connected server wherein a consumer's store credit balance and merchant business rules reside; and a merchant device with a low-energy transmission access technology, wherein the merchant device recognizes a consumer mobile device and relays a consumer's pre-tax bill amount through the consumer mobile device to the internet connected server, wherein the internet connected server includes logic to apply a consumer's store credit balance to the bill amount and relay an adjusted amount back to the consumer mobile device.

More specifically, embodiments of the present invention provide a system and method for calculating and applying a discount using store credit to a mobile presented bill for payment in store or using a mobile wallet. The system includes a mobile device which a consumer operates. The application provides a mechanism for a consumer to signal their readiness to pay their bill at the participating merchant location using their store credit as a discount during payment.

When the customer indicates, through their mobile device, their readiness to pay their bill, their mobile device broadcasts a signal relating to the payment state which can be read by a physical beacon device retained by the billing merchant. When the consumer is ready to pay, the beacon device is used by the merchant to manually enter the consumer's bill amount. After entering the relevant numbers, the merchant transmits the information from the device and the amounts are sent to the customer's waiting mobile device.

The transmission is made wirelessly from the merchant's beacon to the mobile device using an established wireless protocol such as Bluetooth low-energy transmission. The consumer's mobile device receives the bill amounts and both relays the presented bill amount to the system's web server over the internet, using the consumer's mobile data wireless subscription plan or an existing Wi-Fi connection, and also renders on the consumer's mobile device the pre-tax total with a request to choose how to pay. The consumer sees the bill total and is prompted to choose how they will pay the bill: with the merchant checkout as normal or via a mobile wallet provider through the consumer's mobile device.

Meanwhile, the system's internet server accepts the amounts of the presented bill relayed by the consumer's mobile device, and applies the appropriate store credit to the amounts based on store credit usage rules established by the merchant and resident on the server. The server next sends the updated bill with the appropriate store credit applied, back to the consumer's mobile device for rendering. This information is sent back to consumer's mobile device from the server over the same Wi-Fi or data network. The server updates the accounting/tracking of the customer's store credit amounts.

After receiving the consumer's response to their payment choice, if the consumer chose to pay with any method other than the consumer's mobile wallet, the mobile device would present the consumer with their applied store credit discount amount on the mobile device screen and the mobile device would also relay a wireless notification to the merchant's beacon device displaying the accurate discount amount to apply during the consumer's manual payment. The mobile device would further display to the consumer that the consumer should continue with the merchant checkout as they normally would and expect to see the appropriate discount on their final bill. The merchant and consumer would then complete the payment applying the appropriate store credit as a discount on the merchant's POS register, collecting the net payment as cash, check or charge and thus applying the store credit securely to the consumer's payment as a discount.

If the consumer chose to pay with their mobile wallet instead, the mobile device presents to the consumer the pre-tax bill amount less the applicable store credit amount plus the new tax amount on the updated total and provides input for any tip the consumer may wish to pay. The consumer can then pay using the identified mobile wallet, as the mobile wallet provider would require over the mobile device. Upon payment confirmation from the mobile wallet, the mobile device wirelessly transmits confirmation of the payment data to the merchant's beacon with confirming information that the bill was paid via the mobile wallet.

At the conclusion of the consumer's payment, the system server creates and sends an email receipt confirmation to the consumer and merchant.

These and other features, aspects and advantages of the present invention will become better understood with reference to the following drawings, description and claims.

### BRIEF DESCRIPTION OF THE DRAWINGS

FIG. 1 is a high-level architectural drawing illustrating the primary components of a system for applying store credit to a presented bill for a discount when paid in store or by mobile wallet according to an exemplary embodiment of the present invention;

FIG. 2 is a block flow diagram illustrating a method in accordance with an exemplary embodiment of the present invention;

FIG. 2A is a block flow diagram extension from FIG. 2;

FIG. 3 is a system block diagram of a merchant device according to an exemplary embodiment of the present invention;

FIG. 4 shows exemplary circuit diagrams of the merchant device of FIG. 3;

FIG. 5 is a sample mobile device input screen to initiate a consumer store credit account balance;

FIG. 6 is a sample mobile device display screen of a consumer store credit account balance and merchant store credit business rules;

FIG. 7 is a sample mobile device display screen of consumer selectable options including pay;

FIG. 8 is a sample mobile device display screen of a presented bill amount and consumer selectable payment choice;

FIG. 9 is a sample mobile device display screen of an updated consumer bill displaying the original bill, applied store credit, updated tax amount and total, with consumer selectable payment confirmation; and

FIG. 10 is a sample mobile device display screen of a consumer store credit account discount amount with instructions to complete payment at POS register.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method that enables a merchant to input a pending bill amount to a blue-tooth enabled beacon device and wirelessly relay that bill amount to a consumer's mobile device. The mobile device can then relay the amount to an internet connected server, which will securely calculate and apply the customer's store credit amount as a discount to the original bill, returning the updated amounts to the customer's mobile device for either manual payment or for payment using the customer's mobile wallet choice. Subsequently, the consumer's mobile device will relay the appropriate net bill information to the blue-tooth enabled beacon device for display and then manual updating of a POS register.

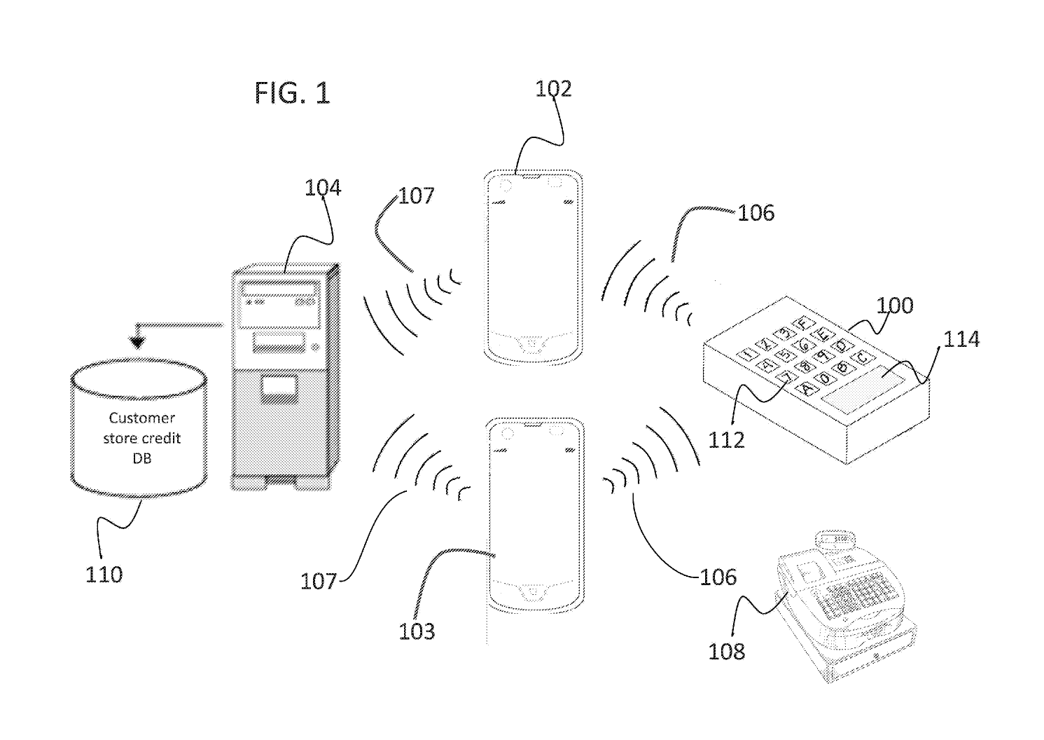

FIG. 1 is a high-level architectural drawing illustrating the primary components of a system to apply store credit, instant discount or gift to a presented bill for a reward when paid in store or by mobile wallet. The reward application system includes a merchant device 100 that is capable of communicating with a consumer's mobile device 102 and an internet connected server 104 and a merchant mobile device 103 capable of communicating with the internet connected server 104. The merchant device 100, the consumer's mobile device 102 and the merchant mobile device may all be linked together by a wireless radio transmission 106, Wi-Fi or Data Plan Transmission 107 (collectively referred to as a wireless transmission). A point of sale register 108 may be used by the merchant as was typically used prior to implementation of the reward application system of the present invention. In other words, the merchant does not need any special point of sale register or any special upgrade—they may simply continue to use the system in place while adding a reward system for customer satisfaction and loyalty.

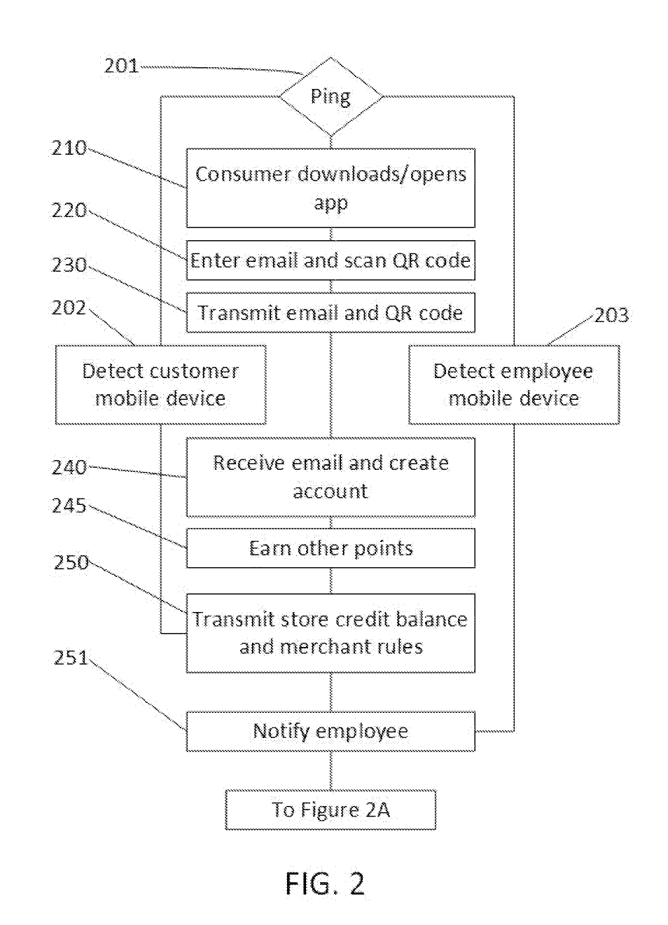

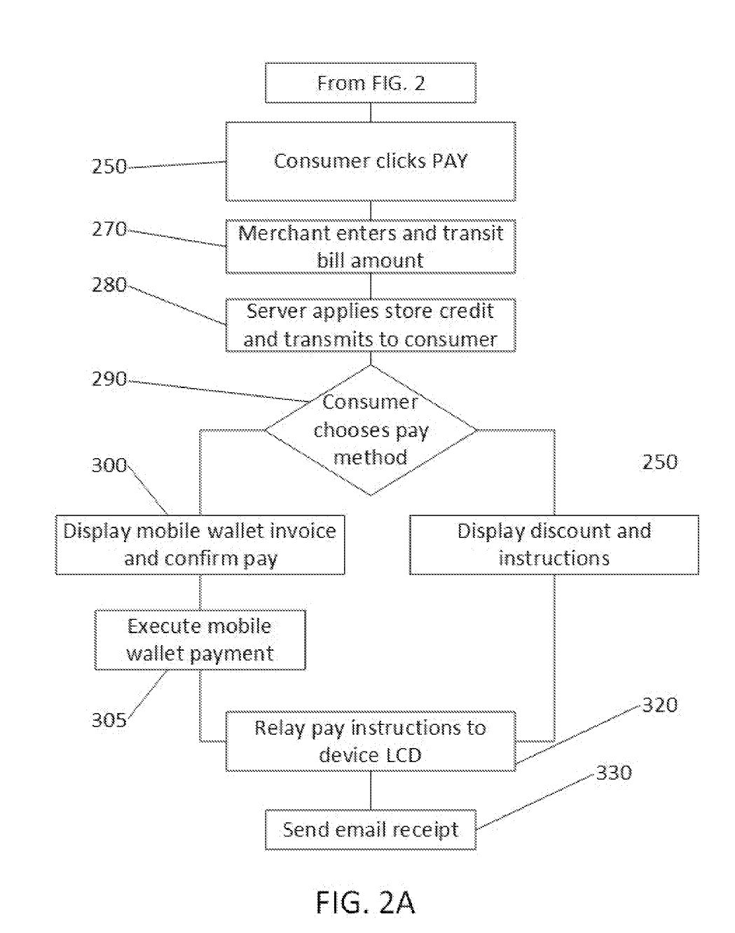

FIG. 2 is a general flow diagram of a method according to an exemplary embodiment of the present invention. Referring to FIG. 2, at step 201, the merchant device 100 is in ready mode pinging out at set intervals, such as 1 per second, to recognize a consumer's mobile device 102 or a merchant mobile device 103. If the merchant device 100 recognizes a device, then the process branches in three possible ways. If the merchant device 100 recognizes the merchant mobile device 103 (in step 203), with a merchant app resident on it, the method steps to 251, where the employee having the merchant mobile device 103 is notified that they are connected to the merchant device 100 and are further notified of any consumer mobile devices 102 recognized by the merchant device 100. If a consumer mobile device 102 with the consumer mobile app is recognized (in step 202), the method moves to step 250. If a consumer mobile device 102 without the consumer mobile app is recognized the method moves to step 210.

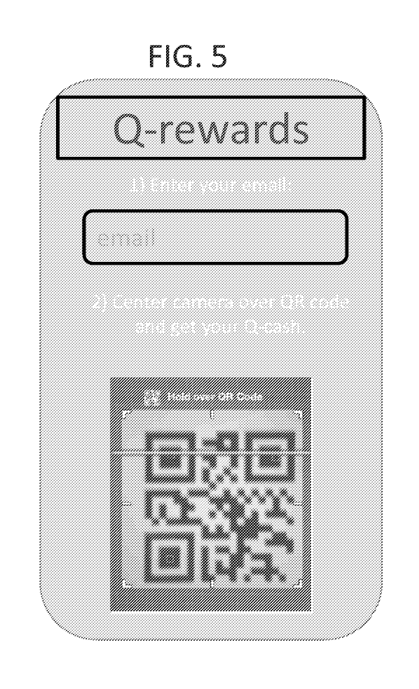

In step 210 a consumer downloads the consumer application to their mobile device 102 and launches the app. Once launched, at step 220, the consumer using the mobile device 102 enters his/her email address and scans the QR code associated with the merchant (FIG. 5) or clicks to opt-in to the merchant associated with merchant device 100. At step 230, upon the app reading the QR code or the clicking of the opt-in, the consumer mobile device 102 communicates with the internet connected server 104 using Wi-Fi, data plan transmission 107 or the like.

At step 240, when the internet connected server 104 receives the transmitted consumer's email and valid QR code or opt-in request, the internet connected server 104 updates the customer store credit database (DB) 110 by creating a consumer account associated with the consumer's mobile device 102 and loading the created account with the appropriate store credit amount, the discount amount or the give-away reward related to the merchant associated with the QR code or the opt-in.

Step 245, which relates to the earning of additional rewards, can occur at any time. The consumer app on the consumer mobile device 102 can be accessed by the consumer and the consumer can undertake activities to earn additional rewards. For example, a consumer can open the consumer mobile app on their consumer mobile device and add a profile picture to their consumer mobile app, thereby earning a 5% reward. Each activity undertaken by the consumer in step 245 is recorded by the internet connected server 104 to the customer store credit DB 110. Step 245 can happen during a single visit, or at any subsequent time.

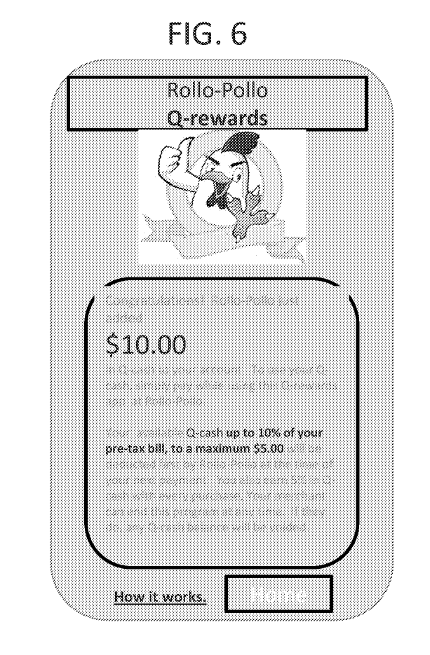

At step 250, the internet connected server 104 transmits a response message back to the consumer's mobile device 102 to display the created store credit, discount or give-away reward value for that consumer's email address (FIG. 6). At step 251, the system updates any merchant-employee apps to notify the employees in the store that the consumer is a registered user and is currently in-store. In one embodiment, the notification to the employees includes information entered into the consumer app, including the consumer's name, picture, likes/dislikes, preferences and the pending reward (store credit, discount or give-away) due the consumer.

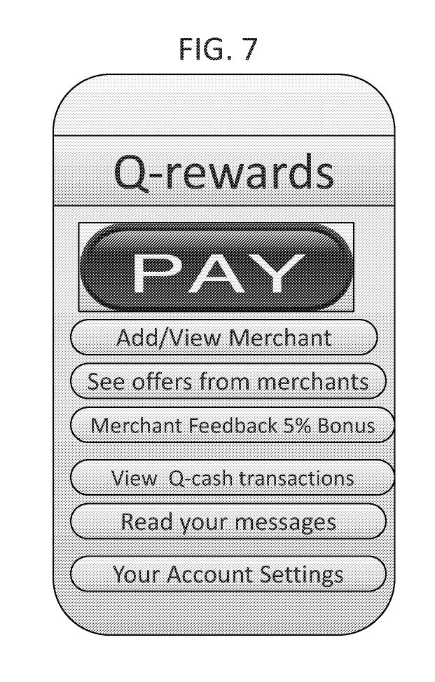

Next, when the consumer enters into a transaction with the merchant and is ready to pay, at step 260 he/she clicks the “Pay” or “checkout” or “claim reward” button on the consumer mobile device 102 (FIG. 7), triggering a wireless transmission 106 to the merchant device 100 with the request.

In response to the request to pay, as step 270, the merchant enters both the pre-tax total of the bill and the tax amount into the POS Register 108 and also into the merchant device 100 using the key-pad 112 resident on the merchant device 100 then transmits the numbers back to the consumer mobile device 102 via wireless transmission 106 which the consumer mobile device 102 immediately transmits through Wi-Fi or data plan transmission 107 to the internet connected server 104. Alternatively, the merchant mobile device 103, using the merchant app, can capture and relay this information. In some embodiments, only the pre-tax total may be required to be entered into the merchant device 100 and the merchant device may be programmed to automatically calculate the tax amount for the merchant.

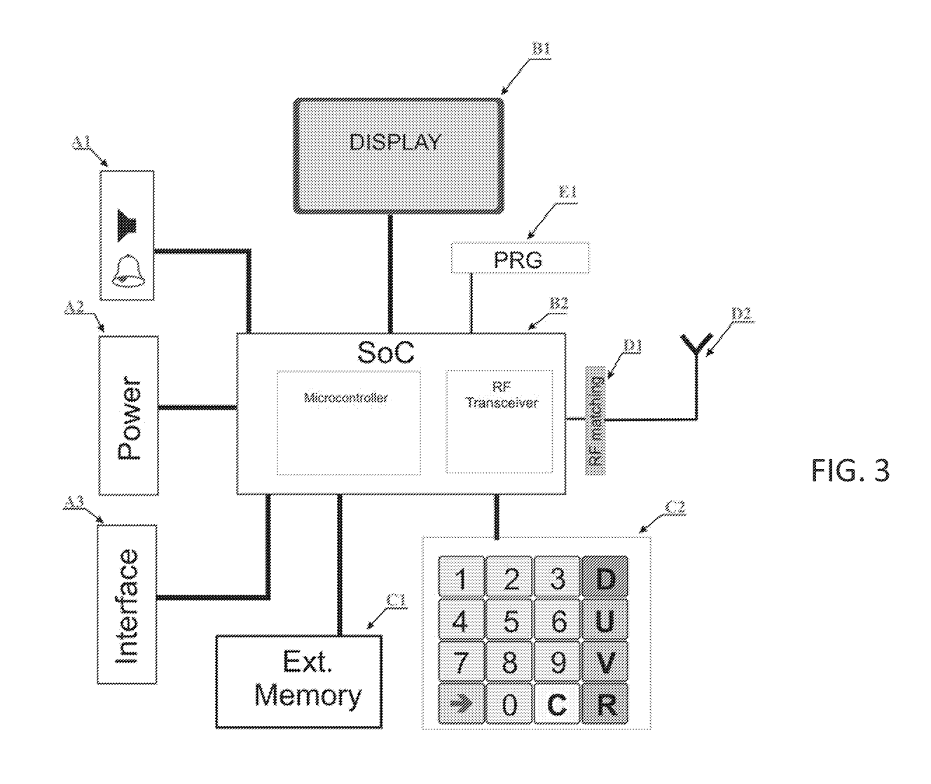

Referring to FIG. 3, the key-pad C2 is connected to the micro-controller B2. The micro-controller B2 transfers the two numbers to the Bluetooth low-energy broadcast mechanism D1 through the radio antennae D2 inside the merchant device 100 to broadcast the two numbers (pre-tax total and the tax amount) to the consumer's waiting mobile device 102 using wireless transmission 106 (FIG. 1).

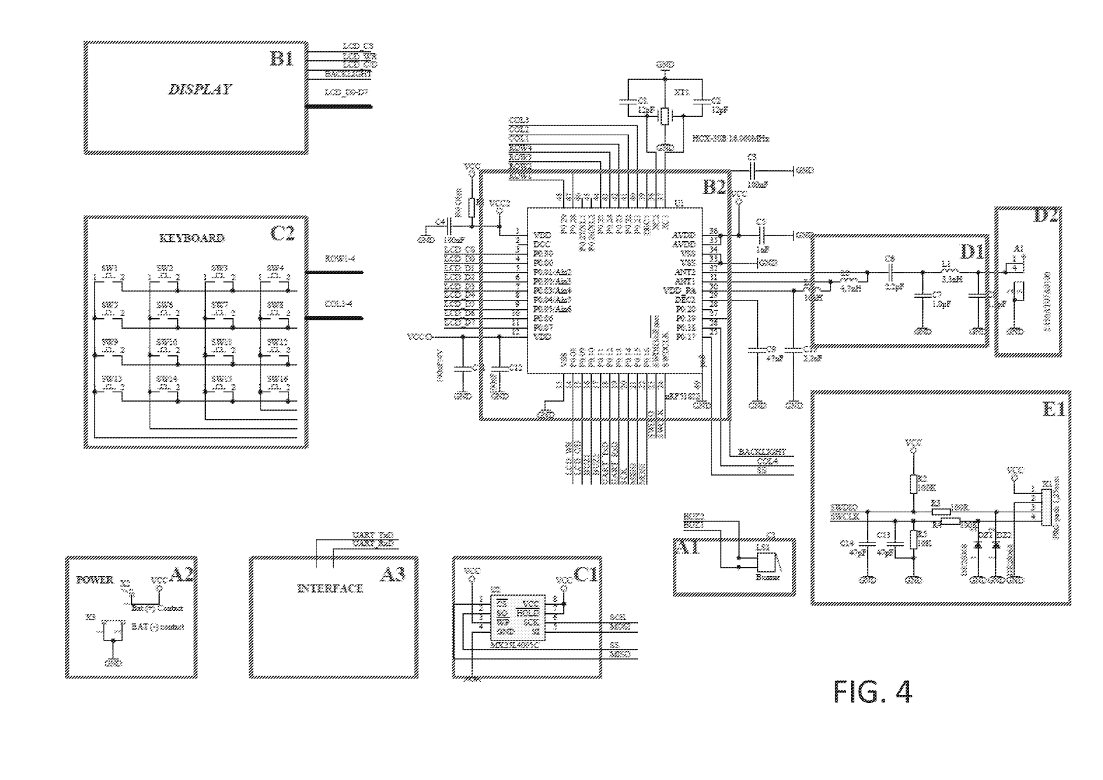

Referring to FIGS. 3 and 4A through 4H, the store credit relaying merchant device in accordance with the present inventions is generally comprised of a system on a chip B2 including a microcontroller and radio frequency transceiver, both controlled by a program E1, the system on a chip B2 further comprises a control circuit assembly (for example nRF51822 Nordic Bluetooth SOC), additionally the device includes a power source A2, external interface A3, alternatively an audio signal A1, external memory C1, a display B1, keypad C2.

At step 280, the internet connected server 104 receives the two numbers associated with the consumer's bill, and calculates the store credit amount or discount, to apply to the consumer's bill at that merchant using the business rules for the merchant residing on the customer store credit DB 110.

The calculation at the server can use the merchant's pre-determined business rules, the pre-tax total, tax amount and the balance of the consumer's store credit or discount database record from the customer store credit DB 110. For example, the server calculation may apply the business rules that the available consumer's store credit balance amount, up to 10% of the pre-tax bill, or a straight 10% discount, up to a maximum of $5.00, should be applied as a discount amount on the pre-tax total. Thus, if the pre-tax total entered on merchant device 100 and relayed is $12.95, and the consumer has a balance of $10 in store credit available or a straight 10% discount earned in their record on the customer store credit DB 110, the system would apply $1.30 in store credit (10% of $12.95 up to a maximum of $5.00), and calculate a new pre-tax total of $11.66 ($12.95 less $1.30 applied store credit discount), and apply the same ratio of tax for the prior pre-tax and tax numbers to the new $11.66 total to determine both the new pre-tax total and the new tax amount. The internet connected server 104 would update the customer store credit DB 110 with these numbers.

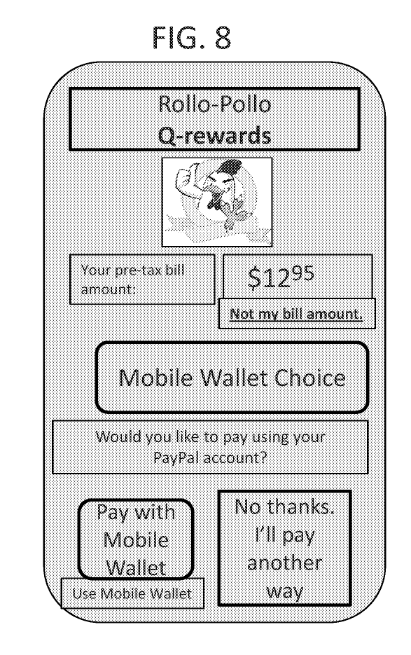

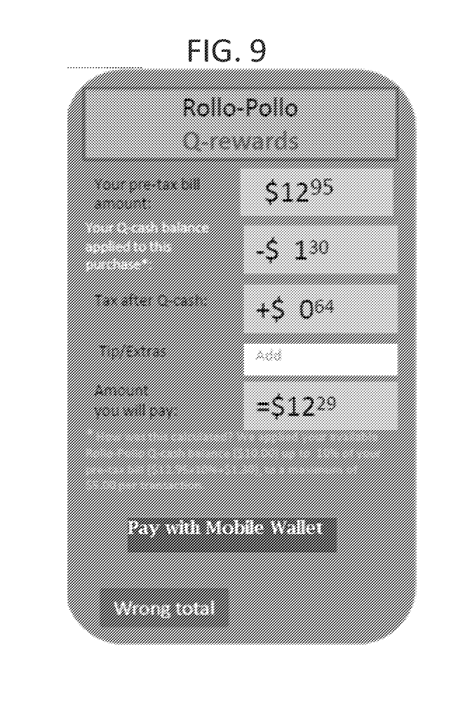

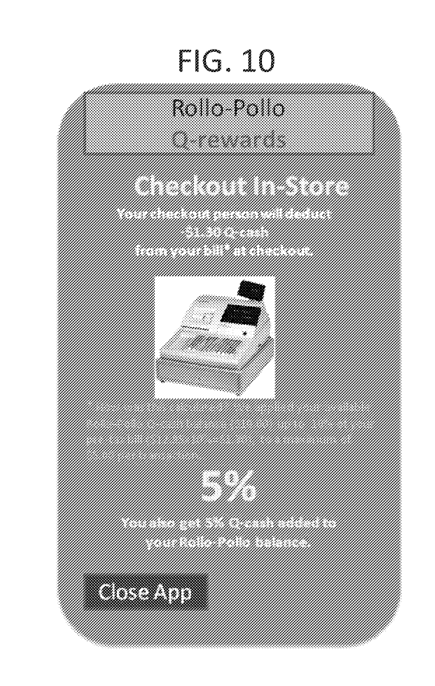

The internet connected server 104 sends the updated two numbers back to the consumer's mobile device 102 over the Wi-Fi or data plan transmission 107 at step 290, triggering a request on the consumer's mobile device 102 for the consumer to identify how they will pay (FIG. 8). The consumer's mobile device 102 receives them and depending on how the consumer chose to pay in step 290 (FIG. 8), the consumer's mobile device 102 will either render the updated totals as an invoice to be paid by the consumer's choice of mobile wallet (step 300 and FIG. 9) or the consumer's mobile device 102 will render only the discount amount and a message relaying instructions to the consumer to complete payment as normal with the merchant (step 310 and FIG. 10).

In some embodiments, instead of a discount, a special offer may be presented to the consumer. For example, instead of getting 10 percent off, the server could send a message through the consumer app on the consumer mobile device to the beacon that the consumer is owed a “non-discount reward”, such as a free dessert, free coffee, or the like. This may be presented to the consumer, for example, at step 202, where the consumer mobile device is detected by the beacon. If the consumer simply takes the offer, no further action is needed with respect to the payment steps. When the “non-discount reward” is accepted, it may be then removed from the user's account.

If the consumer chose to pay with the mobile wallet, at step 305 the consumer executes the mobile wallet payment according to the mobile wallet provider's processes.

At step 320, the consumer's mobile device 102 relays the information relative to the consumer's payment status to the merchant device 100 by wireless radio transmission 106. The merchant device 100 receives the information and displays the appropriate message to the merchant on the display 114 (FIG. 1) resident on the merchant device 100.

For instance, if the consumer opted-to pay with their mobile wallet, at step 320 the display 114 would indicate to the merchant that the bill was paid via the mobile wallet provider for $11.66 pre-tax, and display the tax and any tip amount and further indicate to the merchant that they should update the POS register 108 to show the bill was paid. The merchant will manually update their POS register 108 with the relayed numbers and close out the bill as paid in full with the applied discount and the consumer payment made via the mobile wallet.

If the consumer chose to pay in a manner other than with the wallet (FIG. 8), at step 320, the display 114 on the merchant device 100 would display a message that the merchant should deduct the amount of applied store credit (e.g. $1.30) from the bill on the POS register 108 and collect payment as they normally would to close out the payment in full with the applied discount and the consumer payment made for the remainder.

At the conclusion of the consumer's payment, at step 340 the system server creates and sends an email receipt confirmation to the consumer and merchant.

It should be understood, of course, that the foregoing relates to exemplary embodiments of the invention and that modifications may be made without departing from the spirit and scope of the invention as set forth in the following claims.

What is claimed is:

1. A method for applying store credit to a presented bill for a discount, comprising:
transmitting a bill amount, entered into a merchant device, from the merchant device to a consumer mobile device;
receiving the bill amount on the consumer mobile device;
relaying the bill amount to an internet connected server from the consumer mobile device;
presenting the bill amount on the consumer mobile device;
applying a calculated consumer store credit to the bill amount received by the internet connected server;
transmitting an updated bill amount from the internet connected server back to the consumer mobile device;
recording a consumer payment method choice on the consumer mobile device for the updated bill amount to be paid; and
processing a mobile wallet payment or displaying store credit discount amount and instructions on the consumer mobile device.

2. The method of claim 1, further comprising:
transmitting confirmation of payment information from the consumer mobile device to the merchant device;
receiving payment information on the merchant device; and
displaying confirmation of payment information on a merchant device display.

3. The method of claim 1, further comprising applying the calculated consumer store credit to the entered bill amount on the internet connected server using merchant specific business rules.

4. The method of claim 1, wherein the entering of the bill amount in the merchant device is done on a low energy wireless protocol enabled merchant device.

5. The method of claim 1, wherein the transmitting of the bill amount to or from the merchant device and to or from the consumer mobile device is done using a low energy wireless protocol transmission.

6. The method of claim 1, wherein the transmitting of the bill amount to or from the merchant device and to or from the consumer mobile device is done using radio field identification (RFID), bump, near field communication (NFC) or infrared protocol transmission.

7. The method of claim 1, wherein the transmitting of the bill amount to or from the merchant device and to or from the consumer mobile device is done using a memory dongle physically passed between a merchant and the consumer.

8. The method of claim 1, wherein relaying the bill amount to or from the internet connected server and to or from the consumer mobile device is done through a Wi-Fi connection or a mobile device data plan.

9. The method of claim 1, wherein presenting or displaying the bill amount or payment information or consumer payment choice on the consumer mobile device is done through a software application resident on the consumer mobile device.

10. The method of claim 1, wherein processing the mobile wallet payment is done using protocols of a mobile wallet provider.

11. The method of claim 1, further comprising transmitting consumer information to and displaying the consumer information on a merchant mobile device when the consumer mobile device is detected by the merchant device.

12. The method of claim 11, wherein the consumer information includes at least one of a customer name, a customer photo, customer preferences, and an amount of consumer store credit available to the consumer.

13. A merchant device to transfer a bill amount, tax amount, tip amount and a store credit discount amount to and from a consumer mobile device, comprising:
a microprocessor;
a control program;
a wireless transceiver;
a display;
a keypad; and
an external memory, wherein
the merchant device uses the microprocessor to operate the control program to receive a pre-tax and tax amount entered through the keypad; and
the control program transmits, via the wireless transceiver, the amounts to the consumer mobile device, wherein the consumer mobile device transmits updated amounts back to the merchant device and the display shows the updated amounts for a merchant to input on a merchant's point of sale register.

14. A system comprising:
an internet connected server wherein a consumer's store credit balance and merchant business rules reside; and
a merchant device with a low-energy transmission access technology, wherein
the merchant device recognizes a consumer mobile device and relays a consumer's pre-tax bill amount through the consumer mobile device to the internet connected server, wherein the internet connected server includes logic to apply a consumer's store credit balance to the bill amount and relay an adjusted amount back to the consumer mobile device.

15. The system of claim 14, wherein the merchant device is distinct and independent from a point of sale system used by a merchant.

16. The system of claim 14, wherein the consumer mobile device concludes a mobile wallet payment in the adjusted amount or displays instructions for completing a transaction at a merchant point of sale register.

17. The system of claim 14, wherein the consumer mobile device includes a wireless transmission protocol selected from at least one of a low-energy transmission technology, Wi-Fi data transmission access, and cellular data transmission access.

18. The system of claim 14, further comprising:
a wireless network accessible by the consumer mobile device; and
a point of sale register.
